(19) United States
(12) Patent Application Publication
(10) Pub. No.: US 2025/0040562 A1
(43) Pub. Date: Feb. 6, 2025

(54) PLANT-BASED PROTEIN MIXTURES

(71) Applicant: Compagnie Gervais Danone, Paris (FR)

(72) Inventors: Paola FLABBI, Madrid (ES); Sylvain DUPORCQ, Lyon (FR); Adrian SUAREZ GARCIA, El Entrego Asturias (ES)

(21) Appl. No.: 18/723,841

(22) PCT Filed: Dec. 22, 2022
(86) PCT No.: PCT/EP2022/087499

§ 371 Date: Jun. 24, 2024

(30) Foreign Application Priority Data
Dec. 24, 2021 (EP) 21315295.2

(51) Int. Cl. A23C 11/10; A23L 11/50; A23L 25/00

(52) U.S. Cl. CPC A23C 11/106; A23L 11/50; A23L 25/40

(57) ABSTRACT

The present invention relates to a process for the preparation of a fermented plant-based composition comprising the step of: a) providing a mixture comprising i) at least one vegetal protein isolate, ii) at least one vegetal protein concentrate, and b) fermenting the mixture with at least one lactic acid bacteria to obtain a fermented plant-based composition.

### FIELD OF THE INVENTION

The present invention generally relates to fermented plant-based food products and processes to prepare the same. More specifically, the present disclosure is directed to plant-based food products that have improved texture and organoleptic qualities.

### BACKGROUND OF THE INVENTION

There is increased interest in plant-based diets among mainstream consumers who consider themselves vegan, vegetarian or flexitarian. To cater to the dietary needs of such consumers a wide variety of plant-based analogues or alternatives to non-vegan food products are increasingly available. These include plant-based dairy alternatives such as milks, yogurts, cheeses, frozen desserts, coffee creamers, whipping and cooking alternatives. The formulation of such products to provide a textural sensory and/or nutritional equivalent to dairy products remains challenging.

This is especially the case in the formulation of “high protein” fermented food products which are also increasingly popular with consumers. Unfortunately, commonly used plant-based proteins, such as pulse protein, are associated with off-notes and textural challenges, particularly when used in fermented products such as plant-based yogurt alternatives (“PBAYs”) as it results in very viscous and grainy textures.

Several commercial plant-based products, in particular plant-based alternative yogurts, do not meet the consumer's needs. Indeed, many are too expensive, too low in protein content or are deemed unpalatable either based on taste, texture, color, and nutritional content.

Pontonio et al. (2020) Frontiers in Microbiology, 11: 1664 discloses the preparation of a yogurt-style snack based on a blend of rice, lentil and chickpea flours. The amount of protein in the yogurt-style snack is less than 4% w/w.

Patent application US2020/060310 relates to the preparation of myceliated high-protein food product, including culturing a filamentous fungus in an aqueous media having a high level of protein.

The article Monika et al. (2019) Journal of the Science of Food and Agriculture, 99: 5852-5857 relates to the preparation of yogurt-type preparation by lactic acid fermentation of an oat protein concentrate suspension after subjection to heat treatment to assure starch gelatinization.

The patent application US2019/239535 concerns a method for producing a black-eyed pea protein isolate as well as food and beverage products including the black-eyed pea protein isolate.

The patent application US2020/296982 discloses non-dairy fermented food product comprising pea protein.

Mintel (2020) “Plain Greek Yogurt Alternative” and Mintel (2019) “Key lime crumble flavoured coconut yogurt alternative & toppings” disclose plant-based yogurt prepared with pea protein isolate and potato protein. Both yogurts comprise less than 4% w/w protein.

Therefore, a need exists for a composition that overcomes one or more of the current textural and organoleptic disadvantages noted above.

### BRIEF SUMMARY OF THE INVENTION

The present invention arises from the unexpected finding by the inventors that concentrated fermented plant-based composition comprising at least one protein concentrate and at least one protein isolate have reduced protein off-notes and an improved texture.

The problem of bad taste associated to the use of vegetal protein is very common for all vegetal protein sources.

The inventors have surprisingly found that the use of a mixture of at least one vegetal protein concentrate and at least one vegetal protein isolate, in particular at least one pulse protein concentrate and at least one pulse protein isolate, for preparing a fermented plant-based composition does not result in an increase of off-notes associated with the use of vegetal protein concentrate and vegetal protein isolate, having both individually strong off-notes, but on the contrary results in a product having reduced protein off-notes.

Thus, the present invention relates to a plant-based protein mixture comprising i) at least one protein isolate, and ii) at least one protein concentrate, and iii) optionally water.

The present invention also relates to a plant-based composition comprising the protein mixture as defined above.

The present invention also relates to a process for the preparation of a fermented plant-based composition comprising the steps of:
a) providing a mixture comprising i) at least one vegetal protein isolate, ii) at least one vegetal protein concentrate; and
b) fermenting the mixture with at least one lactic acid bacteria to obtain a fermented plant-based composition.

The present invention also relates to a fermented plant-based composition obtained by the process as defined above.

The present invention also relates to a fermented plant-based composition, in particular a concentrated fermented plant-based composition, comprising i) at least one vegetal protein isolate and ii) at least one vegetal protein concentrate.

The present invention also relates to a plant-based alternative yogurt comprising a concentrated fermented plant-based composition as defined above.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

### DETAILED DESCRIPTION

### Definitions

In the specification and in the claims, the terms “including”, “comprising” and “containing” can be used interchangeably. These terms are open-ended terms and should be interpreted to mean “including”, but not limited to. Thus, when an object “comprises” or “contains” one or several elements, other elements than those mentioned may also be included in the object. These terms encompass the more restrictive terms “consisting essentially of” and “consisting of.” When an object is said to “consist of” one or several elements, the object is limited to the listed elements and cannot include other elements than those mentioned.

It must be noted that as used herein and in the appended claims, the singular forms “a”, “an”, and “the” include plural references unless the context clearly dictates otherwise. As well, the terms “a”, “an”, “one or more” and “at least one” can be used interchangeably herein.

As used herein, the term “ppm” shall be taken to mean “parts per million”. One gram in 1 liter is 1000 ppm and one thousandth of a gram (0.001 g) in 1 liter is one ppm.

As used herein, the term “x % w/w” is equivalent to “x g per 100 g”. Unless indicated otherwise, all % value shall be taken to indicate x % w/w.

In the context of this application, the term “at least” also includes the starting point of the open range. For example, an amount of “at least 95.00% w/w” means any amount equal to 95.00 percentage by weight or above.

In the context of this application, the term “about” defines a range of plus or minus 10% of the cited value. For example, an amount of “about 20 weight %” means any amount within the range of 18.00 to 22.00 weight %.

In the context of this application, unless otherwise provided, amounts refer to amounts by weight.

As used herein the term “plant-based” shall be taken to mean a composition or product which comprises vegetal, plant or plant-derived matter but does not comprise animal or animal-derived matter including but not limited to dairy, egg, fish, shellfish, meat, dairy milk and insects.

As used herein the term “vegetal” shall be taken to mean edible parts of a plant including but not limited to vegetables, fruits, flowers, stems, seeds, leaves and roots.

The “dry matter” of a product corresponds to the weight of non-volatile components present in the product, relatively to the total weight of the product, after total evaporation, i.e. complete removal of water. The dry matter is expressed as a weight percentage. The “non-volatile components” correspond to the solids that remain after evaporation of the water of the product.

As used herein the adjective “dairy” shall be taken to mean a composition or product comprising or consisting of mammalian milk matter, i.e., the lacteal secretion obtainable by milking.

As used herein the terms “free” or “free from” shall be taken to mean a composition or product which preferably does not contain a given substance but where trace amounts or contaminants thereof may be present. Thus, the terms “free” or “free form” means that the given substance is present in the composition or product in an amount lower than 0.1%, more preferably lower than 0.05%, even more preferably lower than 0.01%. More preferably, the terms “free” or “free form” means that the composition or product does not contain detectable amount of the substance.

As used herein the terms “plant-based alternative”, “analogue” or “substitute” shall be taken to mean a plant-based food or beverage composition that is formulated to simulate the organoleptic and/or nutritional qualities of an equivalent non-plant-based product.

As used herein, the term “added sugar” shall refer to sugars that are added during the processing of foods (e.g., plant matter processed to provide a vegetal base, sugars added as nutriment for the fermentation) as opposed to sugars naturally occurring in said foods. Added sugars include sugars (free, mono- and disaccharides), sugars from syrups and honey, and sugars from concentrated fruit or vegetable juices that are in excess of what would be expected from the same volume of 100 percent fruit or vegetable juice of the same type.

As used herein, the term “fermented plant-based” shall be taken to mean a product or composition that is the product of the acidifying fermentation of a plant-based composition by a starter culture of fermenting microorganisms, in particular bacteria, preferably lactic acid bacteria.

As used herein, the expressions “concentrated plant-based composition” or “concentrated fermented plant-based composition” refer to a mixture which has been subjected to a post-fermentation concentration process.

As used herein the term “strained fermented food product” is equivalent to “concentrated fermented food product” and shall be taken to mean a food product which has been subjected to a post-fermentation concentration process.

As used herein the term “spoonable” shall be taken to mean a fluid, or a semi-solid that may be consumed by means of a spoon or other utensil.

As used herein, the “fat content” of a composition corresponds to the weight of the fat components present in the composition relatively to the total weight of the composition. The fat content is preferably expressed as a weight percentage.

As used herein, the % w/w protein in a composition is calculated according to the Kjeldahl-method by measuring total nitrogen and using a conversion factor of 6.25.

### Protein Mixture

The present invention provides protein mixtures suitable for use in the plant-based compositions and processes as described herein.

In embodiments the protein mixtures of the invention comprise i) one or more vegetal protein isolates, ii) one or more vegetal protein concentrates and optionally iii) water.

As will be clear for the person skilled in the art, the plant-based protein mixture according to the present embodiments may comprise i) one or more vegetal protein isolates, and ii) one or more vegetal protein concentrates. As will be clear for the person skilled in the art, the protein isolate and the protein concentrate according to the present embodiments may come from the same vegetal variety or not.

By way of example, the plant-based protein mixture according to the present embodiments may comprise: i) at least two vegetal protein isolates from the same or different vegetal varieties, notably chosen among soy and pulses, and ii) at least one vegetal protein concentrate from the same or a different vegetal variety than the vegetal variety of the protein isolates, notably chosen among soy and pulses.

By way of example, the plant-based protein mixture according to the present embodiments may comprise i) a combination of at least one vegetal protein isolate and at least one vegetal protein isolate which has been hydrolyzed, and ii) at least one vegetal protein concentrate.

Preferably, the amount of protein, brought by the ingredients, in the protein mixture according to the present embodiments before the concentration is comprised between about 1.5 and 6% w/w.

Preferably, the ratio of protein coming from the at least one vegetal protein isolate to the at least one vegetal protein concentrate in the plant-based protein mixture is from about 85:15 to about 30:70, e.g. about 80:20, about 78:22, about 75:25, about 72:28, about 70:30, about 68:32, about 65:35, about 62:38, about 60:40, about 58:42, about 55:45, about 52:48, about 50:50, about 48:52, about 45:55, about 42:58, about 40:60, about 38:62, or about 35:65. More preferably, the ratio of the protein coming from the at least one protein isolate to the at least one protein concentrate in the plant-based protein mixture is from about 58:42 to 65:35.

Preferably, the protein mixture according to the present embodiments comprises from about 0.45% w/w to 5.1% w/w, preferably from about 0.85% w/w to 4.00% w/w of protein coming from the at least one vegetal protein isolate.

Preferably, the protein mixture according to the present embodiments comprises from about 0.20% w/w to 4.5% w/w, preferably from about 0.50% w/w to about 2.55% w/w of total protein coming from the at least one vegetal protein concentrate.

Preferably, the plant-based composition according to the present embodiments comprises from 1.5 to 6% w/w total nitrogen. Preferably, from 30 to 85% of the total nitrogen of the plant-based composition according to the present embodiments come from the protein isolate. Preferably, 15 to 70% of the total nitrogen of the plant-based composition according to the present embodiments come from the protein concentrate.

The expression “protein concentrate” as used herein, generally refers to protein derived from a plant source that has been extracted from the plant source and purified. Protein concentrate may comprise up to about 60%, up to 65%, up to 66%, up to 67%, up to 68%, up to 69%, up to 70% w/w or more total protein on a dry matter basis e.g., 50% up to 70% w/w. More preferably, the protein concentrate comprises up to 70% w/w, or up to 69% w/w total protein on a dry matter basis.

Preferably, the protein concentrate comprises from 50% w/w to 70% w/w total protein, e.g., from 55% w/w to 70% w/w, from 60% w/w to 70% w/w, from 62% w/w to 70% w/w, from 64% w/w to 70% w/w, from 66% w/w to 70% w/w, from 68% w/w to 70% w/w total protein on a dry matter basis or from 50% w/w to 69% w/w, from 50% w/w to 68% w/w, from 50% w/w to 67% w/w, from 50% w/w to 66% w/w, from 50% w/w to 65% w/w, from 50% w/w to 62% w/w, from 50% w/w to 60% w/w total protein on a dry matter basis.

Preferably, the protein concentrate according to the invention comprises up to 69% w/w total protein on a dry matter, e.g., from 50% w/w to 69% w/w, from 55% w/w to 69% w/w, from 60% w/w to 69% w/w, from 62% w/w to 69% w/w, from 64% w/w to 69% w/w, from 66% w/w to 69% w/w, from 68% w/w to 69% w/w total protein on a dry matter basis.

Preferably, the rest of the dry matter of the vegetal protein concentrate comprises carbohydrates such as starch and fibers. A protein concentrate may comprise a single type of protein or a combination of different types of proteins. A protein concentrate may comprise a protein from a single vegetal variety or a combination of different vegetal varieties. A protein concentrate can be deflavored or not.

The expression “protein isolate” as used herein, generally refers to protein derived from plant source that has been extracted from the plant source and purified. Protein isolate may comprise greater than or equal to about 70%, 71%, 72%, 73%, 74%, 75%, 80%, 85% 90% w/w, or more total protein on a dry matter basis e.g., 70% to 95% w/w total protein on a dry matter basis.

Preferably, the protein isolate according to the invention comprises from 70% w/w to 95% w/w total protein on a dry matter basis, e.g., from 71% w/w to 95% w/w, from 72% w/w to 95% w/w, from 75% w/w to 95% w/w, from 78% w/w to 95% w/w, from 80% w/w to 95% w/w, from 82% w/w to 95% w/w, from 85% w/w to 95% w/w, from 88% w/w to 95% w/w, or from 90% w/w to 95% total protein on a dry basis mater, or from 70% w/w to 90% w/w, from 70% w/w to 88% w/w, from 70% w/w to 85% w/w, from 70% w/w to 82% w/w, or from 70% w/w to 80% w/w.

Preferably, the protein isolate according to the invention comprises more than 70% w/w total protein on a dry basis matter such as at least 71% w/w, at least 72% w/w, at least 73% w/w, at least 74% w/w, or at least 75% w/w total protein on a dry basis matter, e.g., from 71% w/w to 95% w/w, from 72% w/w to 95% w/w, from 73% w/w to 95% w/w, from 74% w/w to 95% w/w, or from 75% w/w to 95% w/w total protein on a dry basis matter.

A protein isolate may comprise a single type of protein or a combination of different types of proteins. A protein isolate may comprise a protein from a single vegetal variety or a combination of different vegetal varieties. A protein isolate may comprise at least one protein isolate which has been hydrolyzed and/or deflavored. By way of example a protein isolate may comprise a combination of at least one protein isolate and at least one protein isolate which has been hydrolyzed.

As intended herein, the expression “hydrolyzed proteins” refers to proteins which have been hydrolyzed into their amino acids and peptides components. The hydrolysis of the proteins may be carried out by any method well known to the person skilled in the art. By way of example, the hydrolysis can be accomplished by a chemical process, e.g., by adding the protein in an acid-based solution or using various enzymes such as proteases.

As intended herein, the expression “deflavoured” refers to proteins which have been treated to reduce or remove off-notes such as bitterness or to provide a neutral tasting food preparation ingredient.

The vegetal protein isolate and the vegetal protein concentrate according to the present embodiments preferably come from, but are not limited to, pulse proteins.

Pulses according to the invention can be any pulses well known from the person skilled in the art. By way of example of pulses according to the present embodiments, it is possible to cite soy; lupins; cowpeas; black matpe (also known as black gram); lentils, in particular beluga lentils (also known as black lentils), brown lentils (also known as sabut masoor), French green lentils, green lentils, split lentils, black lentils, red lentils; beans, in particular green beans, black bean, adzuki beans (also known as red mung bean or haricot adzuki), Anasazi beans (also known as aztec bean, cave bean or new Mexico appaloosa bean), appaloosa beans, baby lima beans (also known as sieva beans), black calypso beans (also known as orca bean), black turtle beans (also known as haricot mungo), dark red kidney beans, great northern beans, red Mexican bean, Jacob's cattle trout beans, faba bean (also known as fava beans or horse bean), large lima beans, light red kidney beans, mung beans (also known as green gram), pink beans, pinto beans, romano beans, cranberry bean, scarlet runner beans, tongue of fire, white kidney beans, white navy beans (also known as white pea bean), yellow beans, mottled bean, red Mexican bean, small red bean, mottled bean, Madagascar bean; peas, in particular field peas, black-eyed peas, split peas, dry peas, green peas, marrowfat peas, pigeon peas, yellow peas, yellow-eyed peas, vetches; haricot; chickpeas, in particular Bengal gram, garbanzo beans, and Bambara beans; and/or combinations thereof.

Particularly preferred pulses according to the invention are selected from the group consisting of soy, peas, faba beans, lupins, lentils, chickpeas and/or combinations thereof.

Most preferred pulse proteins according to the invention are pea proteins and faba bean proteins.

Several pea sources are readily available to the person skilled in the art, for example, from Roquette (Lestrem, France) which markets a pea isolate obtained from the yellow pea (Pisum sativum), and from Cosucra Groupe Warcoing (Warcoing, Belgium).

### Plant-Based Composition

The present embodiments provide a plant-based composition comprising the protein mixture as defined above.

The plant-based composition according to the present embodiments may further comprise at least one strain of lactic acid bacteria.

The plant-based composition according to the present embodiments may further comprise at least one vegetal base.

The plant-based composition according to the present embodiments may further comprise water.

The plant-based composition according to the present embodiments may further comprise at least one intermediate preparation.

The plant-based composition according to the present embodiments may further comprise at least one fat source.

The plant-based composition according to the present embodiments may further comprise at least one buffering or pH adjusting agent.

The plant-based composition according to the present embodiments may further comprise at least one sugar.

### Water

Water is typically present in an amount balancing the amounts of other ingredients to 100% by weight. In an embodiment water is present in an amount between 65% and 95% by weight, for example from 65% to 90%, or from 65% to 70%, or from 65% to 75%, or from 65% to 80%, or from 65% to 85%, or from 70% to 75%, or from 75% to 80%, or from 80% to 85%, or from 80% to 85%.

In one embodiment the water quality is monitored to ensure sufficiently low level of cations to ensure protein stability is not impacted. The water can be selected from any type of water well-known by the person skilled in the art such as tap water, demineralized water, desalinated water, water filtered by reverse osmosis, deionized water, or low ions content water. By way example, the total cation content can be from about 60 ppm (40 ppm for divalent ions and 20 ppm for monovalent ions) and the hardness of water can be 6 gram/gallon or less.

### Lactic Acid Bacteria

The selection of suitable lactic acid bacteria strains is within the scope of the skilled person and is typically a thermophilic and/or mesophilic lactic acid bacteria. Lactic acid bacteria may be referred to herein as ferments or cultures or starters. Examples of lactic acid bacteria that can be used include but are not limited to Lactobacilli (for example Lactobacillus acidophilus, Lactobacillus buchneri, Lactobacillus delbruckeii, in particular L. delbrueckii subsp. bulgaricus or lactis, Lactobacillus casei, Lactobacillus plantarum, Lactobacillus reuteri, Lactobacillus johnsonii, Lactobacillus helveticus, Lactobacillus brevis, Lactobacillus rhamnosus); Lactococci (for example Lactococcus lactis, typically Lactococcus lactis subsp. lactis or Lactococcus lactis subsp. cremoris), Streptococci (for example, Streptococcus thermophilus, Streptococcus cremoris) and mixture and/or combinations thereof. Typically, a mixture or association of a plurality of species of lactic acid bacteria may be used, typically a mixture or association of Lactobacillus and Streptococcus. For the preparation of plant-based food product thereto this typically includes Lactobacillus bulgaricus (also referred to as Lactobacillus delbrueckii subsp. bulgaricus).

The plant-based composition may optionally include additional microorganisms such as but not limited to aromatic, probiotic species and other species that may provide desirable organoleptic or other qualities to the composition, e.g., Lactococcus lactis.

The plant-based composition according to the present embodiments may optionally include enzymes, such as but not limited to proteases.

The plant-based composition may also optionally include at least one sugar notably as nutriment for the fermentation. Sugars which can be used for the fermentation are well known by the person skilled in the art and include glucose, dextrose, saccharose, etc.

The lactic acid bacteria may be introduced in any appropriate form, for example, in a spray-dried form, a freeze-dried form or in a frozen form, preferably in a liquid form.

Preferably, the lactic acid bacteria according to the present embodiments decreases the pH of the plant-based composition down to 5 to 4.3 or preferably to 4.55 to 4.75 during fermentation.

### Optional Buffering or pH Adjusting Agents

The composition and mixtures described herein may optionally comprise at least one buffering or pH adjusting agent. The buffering or pH adjusting agent according to the invention may be any buffering or pH adjusting agent well known to the person skilled in the art. By way of example of such agents it is possible to cite monophosphates, diphosphates, sodium mono- and bicarbonates, potassium mono- and bicarbonates, for example, potassium phosphate, dipotassium phosphate, potassium polyphosphates, sodium bicarbonate, trisodium citrate (also referred to as sodium citrate), sodium phosphate, disodium phosphate, trisodium phosphate and sodium polyphosphates, sodium bicarbonate, calcium carbonate and/or mixtures or combinations thereof.

### Vegetal Base

The plant-based composition according to the present embodiments may further comprise at least one vegetal base. Preferably, the vegetal base comprises a plant-based matter and can be in any form such as an aqueous suspension or a slurry.

Preferably, the plant-matter is selected from the group consisting of legumes, pulses, nuts, seeds, cereals and/or combinations thereof.

The pulses can be chosen among any pulses well known by the person skilled in the art. Preferably, the pulses are selected from the group consisting of split peas, field peas, dry peas, lentil, chickpeas, garbanzo bean, faba beans, konda, navy bean, white navy bean, white pea bean, pea bean, cow pea, horse bean, haricot, pinot bean, mottled bean, small red bean, red Mexican bean, kidney bean, black bean, black turtle bean, cranberry bean, roman bean, speckled sugar bean, lima bean, haba bean, Madagascar bean, green gram, mung bean, green bean, black gram, urad dal, soy and/or lupin. In preferred embodiments, the pulses are pea and/or chickpea.

The nuts can be chosen among any nuts well known by the person skilled in the art. Preferably, the nuts are selected from the group consisting of almonds, cashews, pecans, macadamias, hazelnuts, pistachio, walnuts or combinations thereof.

The seeds can be chosen among any seeds well known by the person skilled in the art. Preferably, the seeds are selected from the group consisting of hemp, pumpkin, quinoa, sesame, tiger nut, flax, chia, sunflower, coconut and/or combinations thereof.

The cereals can be chosen among ay cereals well known by the person skilled in the art. Preferably, the cereals are selected from the group consisting of wheat, rye, spelt, barley, oat, millet, sorghum, rice, teff and/or combinations thereof.

Processes for the preparation of such aqueous suspensions are known in the art and typically comprise mechanical and/or enzymatic disruption of the plant-matter and hydration and/or combination with a solution, followed by mechanical separation of an aqueous fraction from starchy and/or fibrous matter, e.g., by decanting, centrifugation or filtration.

For example, the plant-based matter may be milled, ground, soaked, dehulled, mixed with water, optionally enzymatic hydrolyzed and/or homogenized etc., in order to produce a suitable aqueous composition.

In particular embodiments, the plant-based matter may be a seed or nut butter such as sunflower, sesame, soy, almond, cashew, hazelnut or peanut butter. Processes for the preparation of nut butters typically comprise wet or dry grinding roasted or unroasted nuts to a paste having a particle size suitable for the preparation of nut beverages.

In other embodiments, the plant-based matter may be a hydrolyzed cereal suspension such as an oat milk or syrup. Processes for the preparation of such cereal suspensions typically comprise mixing an oat material (such as rolled oats, milled oats, oat flour or oatmeal) with water and treated enzymatically by amylases to hydrolyze starch followed by removal of suspended matter.

Particularly preferred is a base that comprises added sugar, where the total carbohydrate content of the vegetal base is derived from plant-based matter selected from the group consisting of legumes, nuts, seeds, cereals and/or combination thereof and added sugar.

In embodiments the added sugar is selected from the group consisting of beet sugar, brown sugar, brown rice sugar, cane juice, cane syrup, cane sugar, caramel, coconut sugar, corn syrup solids, corn syrup, refined sugar, confectioner's sugar, date sugar, maple syrup, malt, molasses, raw sugar, sugar, honey, agave and/or combinations thereof.

In embodiments, the vegetal base further comprises at least one fat source, preferably at least one vegetal fat source.

Preferably, the fat source according to the present embodiments may be in the form of an oil, a cream, a butter, a milk, a paste, and any other form well known by the person skilled in the art.

Preferably the vegetal fat according to the present embodiments are selected from the group consisting of coconut cream, coconut milk, coconut oil, corn oil, almond oil, chia oil, safflower oil, soybean oils, linseed oil, soy oil, grape seed oil, hazelnut oil, rice bran oil, sunflower oil, sesame oil, açai oil, palm oil, brazil nut, passion fruit oil, cashew oil, olive oil, coconut butter, almond butter, peanut butter, hazelnut butter, cashew butter, cashew butter, olive butter nut paste, almond paste, and/or combinations thereof.

More preferably, the fat source is selected from the group consisting of coconut milk, coconut cream, coconut oil, almond paste, sunflower oil, and mixture thereof.

In embodiments, the vegetal base comprises carbohydrates.

Preferably, carbohydrates according to the invention are selected from sugars, starches naturally present in the vegetal protein concentrate, in particular the pulses protein concentrates, and fibers.

Example of sugars according to the present embodiments, include fructose, galactose, glucose, saccharose, sucrose, dextrose, maltose, fructose syrup, sugarcane syrup, and high fructose corn syrup.

By way of examples of fibers according to the present embodiments it is possible to cite fibers found in cereals, fruits, pulses, and vegetables, in particular in fruits, dark green vegetables, orange vegetables, cook dry bean, starchy vegetables, whole grains, more particularly in peas, soybeans, lupins, oats, rye, chia, barley, figs, plums, prunes, berries, bananas, apples, pears, broccoli, carrots, root tuber, root vegetable, sweat potato, nuts, almond, wheat, corn and/or combinations thereof.

### Intermediate Preparation

The plant-based composition according to the present embodiments may further comprise at least intermediate preparation. Intermediate preparations are well known by the person skilled in the art. They are typically used to modify the taste, mouthfeel and/or texture of a food product, for example of a fermented food product. They can be used also to introduce some additives such as nutrients. They typically comprise sweetening agents, flavors, color modifiers, oilseeds, nuts, cereals and/or fruit.

Intermediate preparations are for example slurries such as oilseed slurries, nut slurries and cereals slurries, or fruit preparations.

Flavors include for example fruit flavors, vanilla flavors, caramel flavors, coffee flavors, chocolate flavors.

Oilseed slurries according to the present embodiments can comprise almond paste, pistachio paste, hazelnuts past, nut paste, etc. Preferred oilseed slurries according to the present embodiments are nuts slurries. Cereal slurries according to the present embodiments can comprise oat flour, oat syrup, etc.

The intermediate preparations that comprise fruits are called fruit preparations. Fruit preparations typically comprise fruits. As used herein the term “fruit” refers to any fruit form, including for example full fruits, pieces, purees, concentrates, juices etc.

Examples of fruits include for example strawberry, peach, apricot, mango, apple, pear, raspberry, blueberry, blackberry, passion, cherry, pineapple, banana, fig, prune, coconut, quince, kiwi, and mixtures or associations thereof, such as peach-passion.

The fruits can be for example provided as:
frozen fruit cubes, for example 10 mm fruit cubes, for example Individual Quick Frozen fruit cubes, for example strawberry, peach, apricot, mango, apple, pear fruit cubes or mixtures thereof;
Aseptic fruit cubes, for example 10 mm fruit cubes, for example strawberry, peach, apricot, mango, apple or pear fruit cubes or mixtures thereof;
fruit purees, for example fruit purees concentrated from 2 to 5 times, preferably 3 times, for example aseptic fruit purees, for example strawberry, peach, apricot, mango, raspberry, blueberry or apple fruit purees or mixtures thereof;
single aseptic fruit purees, for example strawberry, raspberry, peach, apricot, blueberry or apple single aseptic fruit purees or mixture thereof;
frozen whole fruits, for example Individual Quick Frozen whole fruits, for example blueberry, raspberry or blackberry frozen whole fruits, or mixtures thereof;
   and/or mixtures thereof.

The intermediate preparation, in particular in the form of a slurry, typically comprises a stabilizing agent, having at least one stabilizer. The stabilizing agent can comprise at least two stabilizers. Such stabilizers are known to the one skilled in the art. They typically help in avoiding phase separation of solids, for examples of fruits or fruits extracts and/or in avoiding syneresis. They typically provide some viscosity to the composition, for example a viscosity (Bostwick viscosity at 20° C.) of from 1 to 20 cm/min, preferably of from 4 to 12 cm/min.

The stabilizing system or the stabilizer can for example be a starch, a pectin, a guar, a xanthan, a carrageenan, a locust bean gum, or a mixture thereof. The amount of stabilizing system is typically of from 0.5 to 5% by weight.

The intermediate preparation can typically comprise organoleptic modifiers. Such ingredients are known by the one skilled in the art.

The organoleptic modifiers can be for example sweetening agents different from sugar, coloring agents, cereals and/or cereal extracts.

Examples of sweetening agents are ingredients referred to as High Intensity Sweeteners, such as sucralose, acesulfamK, aspartam, saccharine.

The ingredients and/or components of the intermediate preparation and the amounts thereof can be typically such that the composition has a brix degree of from 1 to 65 brix, for example from 1 to 10 brix, or from 10 to 15 brix, or from 15 to 20 brix, or from 20 to 25 brix, or from 25 to 30 brix, or from 30 to 35 brix, or from 35 to 40 brix, or from 40 to 45 brix, or from 45 to 50 brix, or from 50 to 55 brix, or from 55 to 60 brix, or from 55 to 60 brix, or from 60 to 65 brix. The Brix degree corresponds to the sugar content of a preparation. Methods for measuring the brix degree are well-known by the person skilled in the art. When measuring the brix degree of a fruit preparation, the fruit preparation is filtered on a sieve of 1 mm, and the supernatant (thus, without fruit pieces) is collected.

A fruit preparation can for example comprise fruit in an amount of from 30% to 80% by weight, for example from 50 to 70% by weight.

The intermediate preparation can comprise water. A part of the water can come from ingredients used to prepare the fruit preparation, for example from fruits or fruit extracts or from a phosphoric acid solution.

The fruit preparation can comprise pH modification agents such as citric acid. The fruit preparation can have a pH of from 2.5 to 5, preferably of from 2.8 to 4.2.

Typically, a fruit preparation or slurries, in particular nut or cereal slurries, can be added in an amount of 5-30% by weight with reference to the total amount of the plant-based composition according to the invention. In embodiments the plant-based composition according to the present embodiments comprises up to about 30% (w/w) of said intermediate preparation, e.g., up to about 10%, 15%, 20%, 25% (w/w). In one embodiment, the plant-based composition according to embodiments of the present invention comprise 0% to 30% (w/w) of said intermediate preparation. In alternative embodiments, the plant-based composition according to embodiments of the invention comprise 1% to 25% (w/w) of said intermediate preparation. In further alternative embodiments, the plant-based composition according to embodiments of the invention comprise 1% to 20% (w/w) of said intermediate preparation. In additional embodiments, the plant-based composition according to embodiments of the invention comprise 1% to 15% (w/w) of said intermediate preparation. In further additional embodiments, the plant-based composition according to embodiments of the invention comprise 1% to 10% (w/w) of said intermediate preparation.

### Food Product

Preferably, the plant-based composition according to the present embodiments is particularly suited for use in a food product such as a dairy-alternative, in particular a plant-based alternative yogurt. Thus, embodiments provide fermented plant-based compositions, in particular concentrated fermented plant-based compositions, suitable for consumption.

Preferably, embodiments provide fermented plant-based food products, in particular concentrated fermented food products, comprising the plant-based composition, as defined herein.

Embodiments also provide a plant-based composition as defined above for use as a plant-based alternative yogurt or in a plant-based alternative yogurt.

Preferably, the plant-based food product, in particular the plant-based concentrated fermented food product, according to the present embodiments comprises at least 4% w/w for example at least 4.5% w/w, or at least 5% w/w, or at least 5.5% w/w or at least 6% w/w or at least 6.5% w/w, or at least 7% w/w, or at least 7.5% w/w, or at least 10% w/w proteins relative to the total weight of the plant-based concentrated fermented composition.

More preferably, the plant-based concentrated fermented composition according to the invention comprises about 4.5% w/w to about 12% w/w, for example from 5% w/w to 11% w/w or from 5% w/w to 10% w/w or from 5.5% w/w to 8.9% w/w or from 5.5% w/w to 8.5% w/w proteins relative to the total weight of the plant-based concentrated fermented composition. Even more preferably, the plant-based concentrated fermented composition according to the invention comprises 8 to 10% w/w proteins relative to the total weight of the plant-based concentrated fermented composition.

Preferably, the plant-based concentrated fermented food product according to the present embodiments comprises:
from about 1.35 to about 12.75% w/w protein from isolate;
from about 0.9 to about 10.5% w/w protein from concentrate.

Preferably, the plant-based concentrated fermented food product according to the present embodiments further comprises from 65.00 to 95.00% w/w water.

Preferably, the plant-based food product according to the present embodiments may further comprise from 0.3 to 10% w/w of fat, preferably from 0.3 to 5% w/w, more preferably from 0.3 to 1.5% w/w of fat of the total weight of the plant-based food product.

Preferably, the plant-based food product, in particular the plant-based concentrated fermented food product, according to the present embodiments further comprise from 2.00% w/w to 15.00% w/w carbohydrates, more preferably from 2 to 6% w/w.

Preferably, the concentrated fermented plant-based food product according to the present embodiments may comprise from 0 to 7% w/w of added sugar, preferably from 0 to 2.5% w/w of added sugar of the total weight of the plant-based food product.

Preferably, the plant-based food product according to the present embodiments may comprise from 2 to 25% w/w of intermediate preparation of the total weight of the plant-based food product.

Preferably, the plant-based food product according to the present embodiments may comprise from 0.20% w/w to 3.00% w/w of pH adjusting agent of the total weight of the plant-based food product.

Advantageously, the use of i) at least one vegetal protein isolate, and ii) at least one vegetal protein concentrate, in the plant-based composition, in particular the plant-based food product, according to the present embodiments minimizes the vegetal protein off-notes, bitterness, astringency, and reduces the texture and viscosity defaults associated with the vegetal proteins, in particular the powderiness, graininess, and stickiness aspects as well as the high viscosity brought by the vegetal protein ingredients.

### Food Form

The plant-based food product according to the invention, in particular the concentrated fermented plant-based food product according to embodiments of the invention, is a spoonable composition, a fermented plant-based alternative to a dairy milk drink, in particular a viscous drink such as but not limited to a yogurt drink, kefir, smoothies etc. and plant-based alternatives thereto.

Preferably, the plant-based food product according to the invention, in particular the concentrated fermented plant-based food product according to embodiments of the invention, is a product selected from the group consisting of plant-based alternative to yogurt, set yogurt, stirred yogurt, strained yoghurt pourable yogurt, yogurt drink, frozen yogurt, kefir, buttermilk, quark, sour cream, fresh cheese, cheese and plant-based alternatives thereto.

More preferably, the plant-based food product according to the invention, in particular the concentrated fermented plant-based food product according to embodiments of the invention, is a plant-based alternative yogurt.

Preferably the plant-based food product, according to the invention has a pH from about 5 to 4.3 or preferably to 4.55 to 4.75.

Preferably the concentrated fermented food product according to the present embodiments has a viscosity greater than 900 mPa·s, greater than 1500 mPa·s, greater than 2000 mPa·s, greater than 2500 mPa·s, preferably greater than 3000 mPa·s, more preferably greater than 3500 mPa·s, greater than 4500 mPa·s, at 10° C. at a shear rate of 64 s−1 after 90 s. In embodiments, the concentrated fermented food product according to the present embodiments has a viscosity range of 900 to 1000 mPa·s, 900 to 1200 mPa·s, 900 to 1500 mPa·s, at 10° C., at a shear rate of 64 s−1 after 90 s. In embodiments, the food product according to the invention has a viscosity range of 1000 to 4500 mPa·s, 1000 to 2500 mPa·s, or 2500 to 3500 mPa·s, at 10° C., at a shear rate of 64 s−1 after 90 s. In embodiments, the food product according to the invention, in particular the fermented food product has a viscosity range of 1500 to 3000 mPa·s, at 10° C., at a shear rate of 64 s−1 after 90 s. The viscosity can be measured by any method well known by the person skilled in the art. By way of example, it is possible to use a Rheometer such as Rheomate system 2-2 at a shear rate of 64 s⁻¹ during 90 s at 10° C.

### Packaging

Preferably, the concentrated fermented plant-based food product according to embodiments of the invention is provided in a sealed or sealable container containing about 50 g, 60 g, 70 g, 75 g, 80 g, 85 g, 90 g, 95 g, 100 g, 105 g, 110 g, 115 g, 120 g, 125 g, 130 g, 135 g, 140 g, 145 g, 150 g, 200 g, 300 g, 320 g, 500 or 900 g or about 1 oz, 2 oz, 3 oz, 4 oz, 5 oz, 6 oz or 12 oz product by weight.

In embodiments, the concentrated plant-based food product according to embodiments of the invention is provided in a sealed or sealable container containing about 50 g to 900 g, 60 g to 500 g, 70 g to 500 g, 75 g to 500 g, 80 g to 500 g, 85 g to 500 g, 90 g to 500 g, 95 g to 500 g, 100 g to 500 g, 105 g to 500 g, 110 g to 500 g, 115 g to 500 g, 120 g to 500 g, 125 g to 500 g, 130 g to 500 g, 135 g to 500 g, 140 g to 500 g, 145 g to 500 g, 150 g to 500 g, 200 g to 500 g, 300 g to 500 g, 320 g to 500 g or 900 g product by weight. In embodiments, the plant-based food product according to embodiments of the invention is provided in a sealed or sealable container containing about 1 oz to 12 oz, 2 oz to 12 oz, 3 oz to 12 oz, 4 oz to 12 oz, 5 oz to 12 oz, 6 oz to 12 oz or 12 oz product by weight.

Preferably, the concentrated plant-based food product, according to embodiments of the invention, may be stored, transported and/or distributed at a temperature of from 1° C. to 10° C. for at least about 30 days, at least about 60 days or at least about 90 days from packaging and remain suitable for consumption.

### Processes for the Preparation of a Fermented Plant-Based Composition

Preferably the process for the preparation of a fermented plant-based composition, in particular a fermented plant-based food product, according to the present embodiments comprises the steps of:
a) providing a mixture comprising i) at least one vegetal protein isolate as defined above, ii) at least one vegetal protein concentrate as defined above, and
b) fermenting the mixture with at least one lactic acid bacteria.

Preferably, the process as defined above comprises the steps of:
a) providing a mixture comprising i) at least one vegetal protein isolate as defined above, ii) at least one vegetal protein concentrate as defined above,
c) heating the mixture, and
b) fermenting the mixture with at least one lactic acid bacteria.

In an embodiment, the process as defined herein further comprise at least one step of d) concentration of the fermented mixture.

Preferably, the process as defined herein may comprise at least one or at least two heating steps and up to three heating steps. Preferably, the process as defined above preferably comprises a step c) of heating the mixture prior to the step b) of fermenting. In an embodiment, the process as defined above may optionally further comprise a step of c1) pre-heating the mixture prior to the step c) of heating the mixture. In an embodiment, the process as defined above may optionally further comprise a heating step c2) after the step b) of fermenting the mixture.

In an embodiment, the process as defined herein may optionally further comprise a step of e) diluting prior to and/or after the step b) of fermenting the mixture and/or after the pre-heating step c1).

In an embodiment, the mixture further comprises a buffering or pH adjusting agent as defined above. Preferably, the buffering or pH adjusting agent is added in the mixture before the heating step c).

In an embodiment, the process as defined above may optionally further comprise the addition of at least one fat source as defined above. The fat source can be added in the mixture at any time of the process. Preferably, the fat source is added in the mixture before the heating step c), and/or before the fermentation step b) and/or after the concentration step d).

In an embodiment, the process as defined above may optionally further comprise the addition of at least one sugar. Preferably, the sugar is added in the mixture before the fermentation step b).

In an embodiment, the process as defined above may optionally further comprise the addition of at least one vegetal base as defined above and/or one intermediate preparation as defined above and/or combination thereof. The at least one vegetal base or intermediate preparation, is preferably added in the mixture before the heat treatment step c), and/or before the fermentation step b) and/or or after the concentration step d), i.e., to the concentrated fermented product.

In a particular embodiment, the process as defined above comprises step a), then step c), then step b) then optionally step e) and then step d).

In a particular embodiment, the process as defined above comprises step a), then optionally step c1), then step c), then optionally step e), then step b) and then step d).

In another particular embodiment, the process as defined above comprises step a), then optionally step c1), then step c) then optionally step e), then step b), then optionally step c2), then optionally step e), and then step d).

### Heat Treatment

Heat treatments are known by the person skilled in the art as, for example, pasteurization or sterilization. Preferably, heat treatments are used to eliminate micro-organism contaminants such as, for example, bacteria. Heat treatment may be performed by direct or indirect heating method optionally associated with flash cooling. Heat treatments may be performed in conventional heat exchangers, such as tube or plate heat exchangers. The heat treatment may, for example, be performed at a temperature of from 80° C. to 150° C., for example, during 2 seconds to 10 minutes.

In an embodiment, the heating step c) is performed at a temperature comprised between 90° C. and 138° C., more preferably between 9° and 100° C., even more preferably between 92 and 98° C. Preferably, the heating step c) is performed during 1 to 10 minutes, more preferably during 2 to 8 minutes, even more preferably during 5 to 7.5 minutes.

In another embodiment, the heating step c) is performed at a temperature comprised between 12° and 150° C. more preferably between 12° and 138° C., even more preferably between 126 and 135° C. for example during 2 to 40 seconds, or during 4 to 35 seconds.

Preferably, the optional pre-heating step c1) carried out before the heating step c) is performed at a temperature comprised between 80 to 150° C., preferably between 92° C. to 138° C. for example, during 2 seconds to 10 minutes preferably during 45 seconds to 5 minutes.

Preferably, the optional heating step c2) carried out after the fermentation step b) is performed at a temperature comprised between 5° and 65° C., more preferably between 55 and 63° C. Preferably, the heat treatment step c2) is performed during 1 to 7.5 minutes, more preferably during 2 to 6 minutes.

### Fermentation

Preferably, during the fermentation step b), the process mixture a) is allowed to ferment at a fermentation temperature to obtain a fermented mixture. The fermentation operations are well known by the person skilled in the art. Preferably the fermentation temperature is comprised between 27° C. and 45° C., more preferably between 35° C. to 40° C.

In an embodiment, the fermentation is performed in presence of at least one additional microorganism such as aromatic, probiotics species.

In an embodiment, the fermentation is performed in presence of at least one enzyme, such as proteases.

In another embodiment, at least one sugar as defined above such as glucose, dextrose, etc., is added before the fermentation step to nourish the fermentation.

Preferably, the viscosity of the mixture before fermentation is lower than 300 mPa·s, more preferably lower than 150 mPa·s, most preferably lower than 100 mPa·s, at 10° C., at a shear rate of 64 s−1 after 10 s. In embodiments, the mixture has a viscosity range before fermentation of 1 to 100 mPa·s, or 1 to 150 mPa·s, or 1 to 200 mPa·s, at 10° C., at a shear rate of 64 s−1 after 10 s. In embodiments, the mixture has a viscosity range before fermentation of 100 to 150 mPa·s, or 100 to 200 mPa·s, or 100 to 250 mPa·s, at 10° C., at a shear rate of 64 s−1 after 10 s.

Preferably, the viscosity of the mixture after the fermentation step is lower than 600 mPa·s, lower than 400 mPa·s, more preferably lower than 200 mPa·s, most preferably lower than 150 mPa·s, at 10° C., at a shear rate of 64 s−1 after 10 s. In embodiments, the mixture has a viscosity range after fermentation of 150 to 300 mPa·s, at 10° C., at a shear rate of 64 s−1 after 10 s.

### Dilution

The process as defined above, optionally further comprises a step of e) diluting. The dilution step can be performed before or after the fermentation step b) or after the concentration step d).

Preferably, the dilution step e) is performed after the fermentation step b) to produce a diluted fermented mixture, by way of example by mixing 1 part by volume of the fermented mixture with at least 0.15 to 1 part by volume of water to produce a diluted fermented liquid mixture.

In an embodiment, the diluting is performed batch-wise. In another particular embodiment, the diluting is performed continuously, throughout the process. In another particular embodiment of the processes described herein, the diluting further comprises mixing.

### Concentration

Preferably the process according to the invention as defined above further comprises at least one step of d) concentration of the fermented mixture.

The concentration according to the present embodiment, may be performed according to any well-known concentration method such as by way of example, any method which can concentrate a precipitated phase by removing or extracting a soluble phase such as whey or permeate and/or any method which can concentrate particles and compounds by physical separation through a filter medium. Preferably, the concentration according to the present embodiment is performed by means of centrifugation or filtration such as membrane filtration.

Preferably, the concentration step provides a plurality of fractions. By way of example of fractions which can be obtained, it is possible to obtain a heavy phase and a light phase, in particular when centrifugation is used, or a retentate phase and a permeate phase, in particular when filtration is used. Preferably, the higher density phase is rich in protein, starch, insoluble fibers and fat and the lower phase is rich in soluble proteins, peptides, carbohydrates, fiber, minerals, and other vegetal compounds.

Preferably, the concentration step is performed on the fermented mixture whether diluted or not and produces a heavy phase or retentate comprising the concentrated fermented plant-based composition or the concentrated fermented food product, and a light phase, or “whey” or permeate.

Preferably, the concentration step is performed at a temperature comprised between 30° C. and 65° C.

In an embodiment, the concentration step is carried out such that the protein concentration in the fermented mixture is multiplied by a factor of at least 1.5, such as at least 3.0 with reference to the protein concentration of fermented product. The factor is preferably at most 5, for example from 1.5 to 5.0 or from 2.0 to 4.5 or from 2.5 to 4. The factor may be at most 7.0 when the concentration step is performed on the diluted fermented mixture.

### Further Processing

In an embodiment, the fermented plant-based composition, in particular the concentrated fermented composition is recovered, preferably after step d) of concentration.

The fermented plant-based composition, in particular the concentrated fermented composition, may optionally be cooled at a temperature comprised between 0° C. and 25° C., by way of example between 0° C. and 20° C., between 4° C. and 15° C., or between 5° C. and 10° C.

The fermented plant-based composition, in particular the concentrated fermented composition, may also optionally be processed for example to a further food form, such as for example smoothed with dynamic mixing technology.

The fermented plant-based composition, in particular the concentrated fermented composition, may also optionally be mixed with further food ingredients, such as a vegetal base as defined above, an intermediate preparation as defined above, in particular fruit preparations, nuts slurries and/or cereals slurries.

The fermented plant-based composition, in particular the concentrated fermented composition, may also optionally be stored, by way of example in a tank.

The fermented plant-based composition, in particular the concentrated fermented composition, may also optionally be, introduced into food packaging and/or used as an ingredient involved in preparing a food.

The invention will be further described by the following non-limiting Examples.

### EXAMPLES 1

The preparation of two plant-based alternative yogurts (“PBAY”) using vegetal protein concentrate and vegetal protein isolate according to the present invention are described below.

### 1. Method

### 1.1. Plant-Based Alternative Yogurt 1

A Protein Mixture was Prepared by Mixing 1 to 2% w/w Protein from Concentrate and 1.6 to 2.6% w/w Protein from Isolate with the Ingredients of Table 1 Below and Water to 100%.

TABLE 1
plant-based alternative yogurt ingredients

| Ingredients | % weight |
|---|---|
| Sugar or dextrose | 1-3% |
| Coconut cream/Sunflower oil | 0.25-1% |
| pH adjusting agent such as | 0.6%-1.2% |
| trisodium phosphate | |

The liquid mixture was then heat treated at a temperature between 126 and 133° C. for 5 to 7 seconds and fermented with a lactic acid bacteria at 43° C. for 5 to 7 hours to provide an unflavoured yogurt type product.

Then, the fermented mixture was diluted with water in a ratio of fermented mixture to water of 20:80. The diluted product was then concentrated into light (“whey” type) and heavy fractions by centrifugation. The heavy fraction comprising the concentrated PBAY type product having 7-8% w/w proteins.

### 1.2. Plant-Based Alternative Yogurt 2

The same steps were repeated however, the fermented mixture was diluted with water in a ratio of fermented mixture to water of 50:50. The diluted product was then concentration into light and heavy fractions by ceramic filtration. The heavy fraction comprising the concentrated PBAY type product having 9-11% w/w proteins.

A taste test was carried out by a panel of testers to evaluate the organoleptic characteristics of plant-based alternative yogurt 1 and 2. No off-notes and astringency was tasted in the plant-based alternative yogurt 1 and 2. The panel of testers has found that the concentrated plant-based yogurts have a smooth texture, were no powdery and floury and have a shiny aspect.

### EXAMPLE 2

The preparation of a plant-based alternative yogurt (“PBAY”) using concentrate proteins only is described below (Comparative example).

A concentrated PBAY was prepared according to Example 1, however the vegetal protein mixture contained only vegetal concentrate. The concentrated PBAY presented a grey/green intense color and presented off-notes described as earthy, mushroom taste, green radish taste. In addition, the concentrated PBAY was unacceptably thick and unprocessable in normal installation. The concentrated PBAY clogged the organic filtration membrane used for the concentration step.

### EXAMPLE 3

The preparation of a plant-based alternative yogurt (“PBAY”) using isolate proteins only is described below (Comparative example).

A concentrated PBAY was prepared according to Example 1, however the vegetal protein mixture contained only plant-protein isolate. The concentrated PBAY was unacceptably astringent, bitter and powdery, not shiny, not smooth in mouth and very high losses of non-recovered solids were observed in the whey by product. It was difficult to concentrate the mixture.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

1. A process for the preparation of a fermented plant-based composition comprising the steps of:
a) providing a mixture comprising i) at least one vegetal protein isolate, and ii) at least one vegetal protein concentrate, and
b) fermenting the mixture with at least one lactic acid bacteria to obtain a fermented plant-based composition.

2. The process according to claim 1, further comprising a step of c) heating the mixture before the step of b) fermenting the mixture.

3. The process according to claim 1, further comprising a step of:
c1) pre-heating the mixture prior to the step of c) heating the mixture, and/or
c2) heating the mixture after the step b) of fermenting the mixture.

4. The process according to claim 1, further comprising a step of d) concentrating the mixture after the step of b) fermenting the mixture to obtain a concentrated fermented plant-based composition.

5. The process according to claim 4, wherein said concentrating step d) is carried out by means of centrifugation and/or filtration.

6. The process according to claim 1, further comprising a step of e) diluting the mixture prior to and/or after step b).

7. A fermented plant-based composition comprising i) at least one vegetal protein isolate, and ii) at least one vegetal protein concentrate.

8. The fermented plant-based composition according to claim 7, further comprising at least one lactic acid bacteria.

9. The fermented plant-based composition according to claim 7, further comprising water.

10. The fermented plant-based composition according to claim 7, further comprising a pH adjusting agent.

11. The fermented plant-based composition according to claim 7, comprising a protein content of about 4% w/w to about 12% w/w relative to the total weight of said fermented plant-based compositions.

12. The fermented plant-based composition according to claim 7, further comprising fat.

13. The fermented plant-based composition according to claim 7, comprising from 0.3% w/w to 10% w/w of fat.

14. The fermented plant-based composition according to claim 7, wherein the at least one vegetal protein isolate and the at least one vegetal protein concentrate are pulse protein.

15. A plant-based alternative yogurt comprising the fermented plant-based composition of claim 7.

16. A plant-based alternative yogurt comprising the fermented plant-based composition made by the process of claim 1.
